(19) United States
(12) Patent Application Publication
(10) Pub. No.: US 2026/0079743 A1
(43) Pub. Date: Mar. 19, 2026

(54) COMPUTING FILLED COMPUTATIONAL WORKFLOW USING GENERATIVE LANGUAGE MODEL

(71) Applicant: Microsoft Technology Licensing, LLC, Redmond, WA (US)

(72) Inventors: Benjamin Livesley THOMAS, Woodinville, WA (US); Estefania Auxiliadora TENORIO SANCHEZ, Seattle, WA (US); Matthew BOLANOS, Seattle, WA (US); Samuel Edward SCHILLACE, Portola Valley, CA (US); Evan CHAKI, North Bend, WA (US)

(73) Assignee: Microsoft Technology Licensing, LLC, Redmond, WA (US)

(21) Appl. No.: 18/888,066

(22) Filed: Sep. 17, 2024

(51) Int. Cl. G06F 9/48

(52) U.S. Cl. CPC G06F 9/4843

(57) ABSTRACT

A computing system including one or more processing devices configured to receive a computational workflow specification. The computational workflow specification includes a plurality of workflow stages. The plurality of workflow stages include one or more unfilled workflow stages that each include a respective workflow stage objective, a respective workflow stage exit criterion, and one or more fillable fields. The computational workflow specification further includes a directed graph structure in which the plurality of workflow stages are arranged. Based at least in part on the computational workflow specification, the one or more processing devices are further configured to compute a filled computational workflow including one or more filled workflow stages. Computing the filled computational workflow includes computing respective filled values of the one or more fillable fields at least in part at a generative language model. The one or more processing devices are further configured to execute the filled computational workflow.

### BACKGROUND

As generative language model capabilities have advanced, generative language models have been incorporated into an increasing variety of scaffolded machine learning (ML) systems. Scaffolded ML systems incorporate ML models into larger computing processes by programmatically calling one or more ML models to perform specified tasks within those systems. The semantic modeling and generation capabilities of a generative language model are accordingly used to perform specific portions of a computational task. The generative language model may, for example, be a large language model (LLM) or a large multimodal model (LMM).

### SUMMARY

According to one aspect of the present disclosure, a computing system is provided, including one or more processing devices configured to receive a computational workflow specification. The computational workflow specification includes a plurality of workflow stages. The plurality of workflow stages include one or more unfilled workflow stages that each include a respective workflow stage objective, a respective workflow stage exit criterion, and one or more fillable fields. The computational workflow specification further includes a directed graph structure in which the plurality of workflow stages are arranged. Based at least in part on the computational workflow specification, the one or more processing devices are further configured to compute a filled computational workflow including one or more filled workflow stages. Computing the filled computational workflow includes computing respective filled values of the one or more fillable fields at least in part at a generative language model. The one or more processing devices are further configured to execute the filled computational workflow.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which a filled computational workflow is computed and executed, according to one example embodiment.

FIG. 2 schematically shows a developer computing device included in the computing system when a computational workflow specification is obtained, according to the example of FIG. 1.

FIG. 3 schematically shows one or more server computing devices included in the computing system when the filled computational workflow is computed, according to the example of FIG. 1.

FIG. 4 schematically shows the one or more server computing devices in an example in which retrieval-augmented generation is performed, according to the example of FIG. 3.

FIG. 5 schematically shows the developer computing device and the one or more server computing devices when one or more workflow generating iterations are performed, according to the example of FIG. 1.

FIG. 6 schematically shows the one or more server computing devices and an end user computing device during execution of the filled computational workflow, according to the example of FIG. 1.

FIG. 7 schematically shows an example filled computational workflow that is executed to perform ticketing support for an end user, according to the example of FIG. 1.

FIG. 8A shows a flowchart of a method for use with a computing system to generate and execute a filled computational workflow, according to the example of FIG. 1.

FIGS. 8B-8D show additional steps of the method of FIG. 8A that may be performed in some examples.

FIG. 9 shows a schematic view of an example computing environment in which the computing system of FIG. 1 may be instantiated.

### DETAILED DESCRIPTION

A computational workflow is a collection of connected workflow stages that are executed to perform some computational task. During construction of a computational workflow, a developer may specify operations performed at the workflow stages, along with a structure according to which the stages are connected. Recently, ML-based code generation has been increasingly integrated into software development. Developers have accordingly used ML models to generate portions of computational workflows.

Prompt chaining is a technique that has been used in some scaffolded ML systems to generate workflows for applications that call generative language models. For example, MICROSOFT PromptFlow makes use of prompt chaining. In prompt chaining, a series of prompts are iteratively used as input to a generative language model over the course of computing a final output. User input or input from other code included in the scaffolded ML system may also be processed at the generative language model during some prompting iterations. Accordingly, the final output of the generative language model is computed over multiple iterations that may have different input types and/or sources. When a developer creates an ML application that has a prompt chaining structure, the developer defines the input sources and types that are input into the generative language model at each stage. The developer also defines output destinations for the outputs of the generative language model.

Some properties of existing prompt chaining techniques limit its flexibility. Therefore, those properties also limit the types of ML application structures it can be used to generate. For example, in prompt chaining, a stage uses the same input source and destination each time it is executed. A prompt chaining workflow is therefore unable to adapt to different input properties or execution conditions. When using prompt chaining, a developer has to indicate all of the eligible input and output types of a workflow stage, which may make it difficult to develop an ML application that incorporates the multimodal input and output capabilities of an LMM. A prompt chaining workflow is also structured as a directed acyclic graph (DAG). Thus, prompt chaining is unable to produce recursive structures that are desirable in some applications, such as applications in which a user repeatedly exchanges conversational turns with an ML model in order to obtain the output of a particular workflow stage. Since prompt chaining is missing the above capabilities, it may be difficult to use prompt chaining to obtain satisfactory workflows for a variety of real-world use cases of ML systems.

In order to address the shortcomings of prompt chaining, the following systems and methods are provided. The systems and methods discussed below allow for the generation of ML system workflows that make use of dynamically selected input sources and output destinations. The data types of the workflow stage inputs and outputs may also be dynamically selected during workflow execution. In addition, the systems and methods discussed below allow for a wider variety of scaffolded ML system topologies, including cyclic graph topologies. Thus, the ML system workflow approaches discussed below allow the capabilities of generative language models to be utilized in a wider range of practical applications.

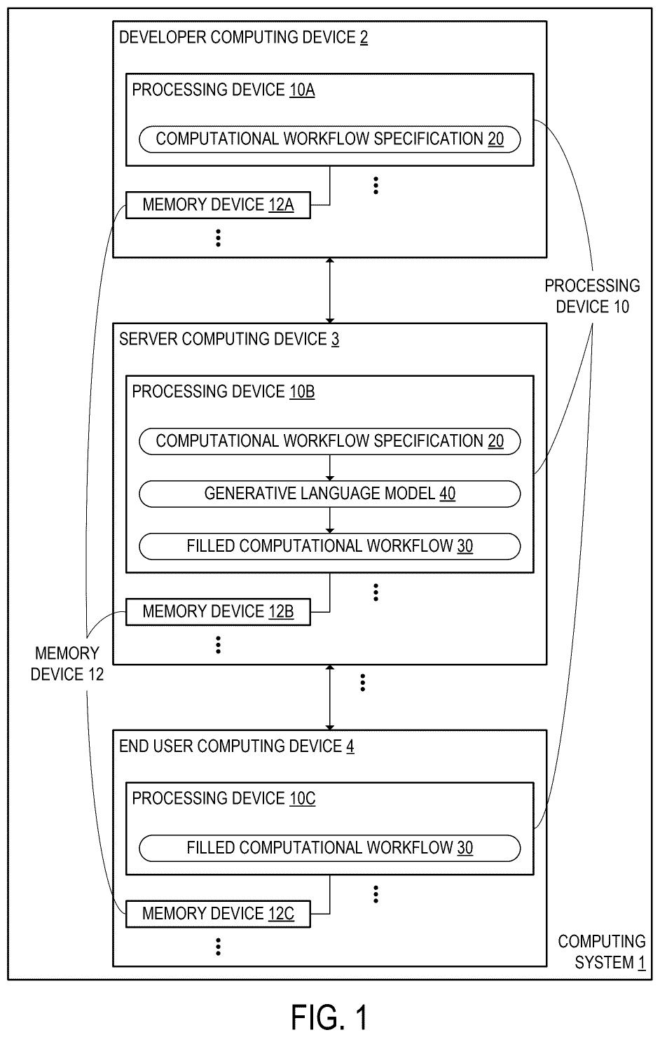

FIG. 1 schematically shows a computing system 1, according to one example embodiment. The computing system 1 includes one or more processing devices 10 and one or more memory devices 12. The one or more processing devices 10 may, for example, include one or more central processing units (CPUs), graphics processing units (GPUs), neural processing units (NPUs), and/or other types of hardware accelerators. The one or more memory devices 12 may, for example, include one or more volatile memory devices and one or more non-volatile storage devices.

In some examples, the one or more processing devices 10 and/or the one or more memory devices 12 may include a plurality of physical components distributed among a plurality of different physical computing devices. The example of FIG. 1 shows a developer computing device 2, one or more server computing devices 3, and an end user computing device 4 that may be included in the computing system 1. The developer computing device 2, the one or more server computing devices 3, and the end user computing device 4 include respective processing devices 10A, 10B, and 10C, and further include respective memory devices 12A, 12B, and 12C. In other examples, some other configuration of the physical computing devices may be used, such as one in which the developer computing device 2 and the end user computing device 4 are combined or one in which the server computing device 3 is omitted.

In the example of FIG. 1, the one or more processing devices 10A of the developer computing device 2 are configured to receive a computational workflow specification 20. This computational workflow specification 20 is transmitted to the server computing device 3, at which the one or more processing devices 10B are configured to compute a filled computational workflow 30 from the computational workflow specification 20. The filled computational workflow 30 is computed at least in part by executing a generative language model 40. After the filled computational workflow 30 has been computed, the one or more processing devices 10B and 10C of the server computing device 3 and the end user computing device 4 are configured to execute the filled computational workflow 30. Thus, in the example of FIG. 1, functionality specified by the developer in the computational workflow specification 20 is incorporated into the filled computational workflow 30 and provided to a user of the end user computing device 4.

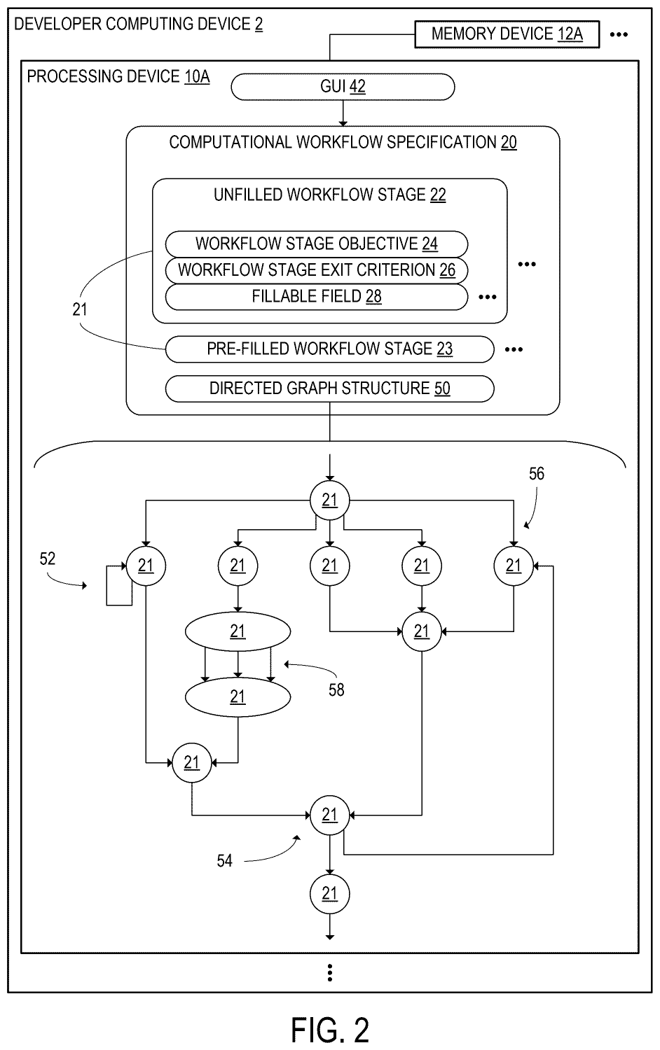

FIG. 2 schematically shows the developer computing device 2 in further detail when the computational workflow specification 20 is obtained. For example, a developer may enter the computational workflow specification 20 at a graphical user interface (GUI) 42. The computational workflow specification 20 includes a plurality of workflow stages 21 that each indicate a respective portion of a computational workflow. Each of these workflow stages 21 may be an unfilled workflow stage 22 or a pre-filled workflow stage 23.

In the example of FIG. 2, each of the unfilled workflow stages 22 includes a respective workflow stage objective 24 that indicates, in high-level semantic terms, a computational task performed at the unfilled workflow stage 22. The workflow stage objective 24 may be a natural-language description of the computational task. For example, the developer may specify a workflow stage objective 24 such as “check the required fields of the form for completeness,” “generate an outline that summarizes the meeting,” “send a two-factor authentication code to the user,” or “extract features from the image.”

Each of the unfilled workflow stages 22 further includes a respective workflow stage exit criterion 26. The workflow stage exit criterion 26 is a condition under which the one or more processing devices 10 are configured to exit the unfilled workflow stage 22 and progress to one or more subsequent workflow stages 21, or, in the case of a final workflow stage 21, the end of the computational workflow. The workflow stage exit criterion 26 may also be indicated in natural language. For example, the workflow stage exit criterion 26 may be “a matching database entry is found,” “five minutes pass with no response from the user,” or “all fields of the form pass a syntactic validity check.”

Each of the unfilled workflow stages 22 further includes at least one fillable field 28. The fillable fields 28 included in the unfilled workflow stages 22 are subsequently filled to obtain the filled computational workflow 30, as shown in FIG. 1.

In examples in which the computational workflow specification 20 includes one or more pre-filled workflow stages 23, those pre-filled workflow stages 23 may each be received as prewritten code or a prewritten prompt for a machine learning model. The workflow stage objective 24 and the workflow stage exit criterion 26 may accordingly be omitted from the pre-filled workflow stage 23.

The computational workflow specification 20 further includes a directed graph structure 50 in which the plurality of workflow stages 21 are arranged within the computational workflow. FIG. 2 schematically shows an example directed graph structure 50 of the computational workflow that demonstrates different types of control patterns that may be used in the computational workflow. In some examples, the directed graph structure 50 is a directed acyclic graph (DAG) structure. Alternatively, as shown in the example of FIG. 2, the directed graph structure 50 may be a directed cyclic graph (DCG) structure that includes at least one cycle pattern 52. The directed graph structure 50 may additionally or alternatively include one or more fan-in patterns 54 in which a workflow stage 21 receives respective inputs from a plurality of other workflow stages 21. The directed graph structure 50 may additionally or alternatively include one or more fan-out patterns 56 in which a workflow stage 21 transmits respective outputs to a plurality of other workflow stages 21. The directed graph structure 50 may additionally or alternatively include one or more map-reduce patterns 58 in which a plurality of outputs of a workflow stage 21 are combined into an input of a subsequent workflow stage 21. The above control patterns may allow the workflow stages 21 to receive and transmit their inputs and outputs in a flexible manner that supports a wider variety of types of operations than existing prompt chaining approaches.

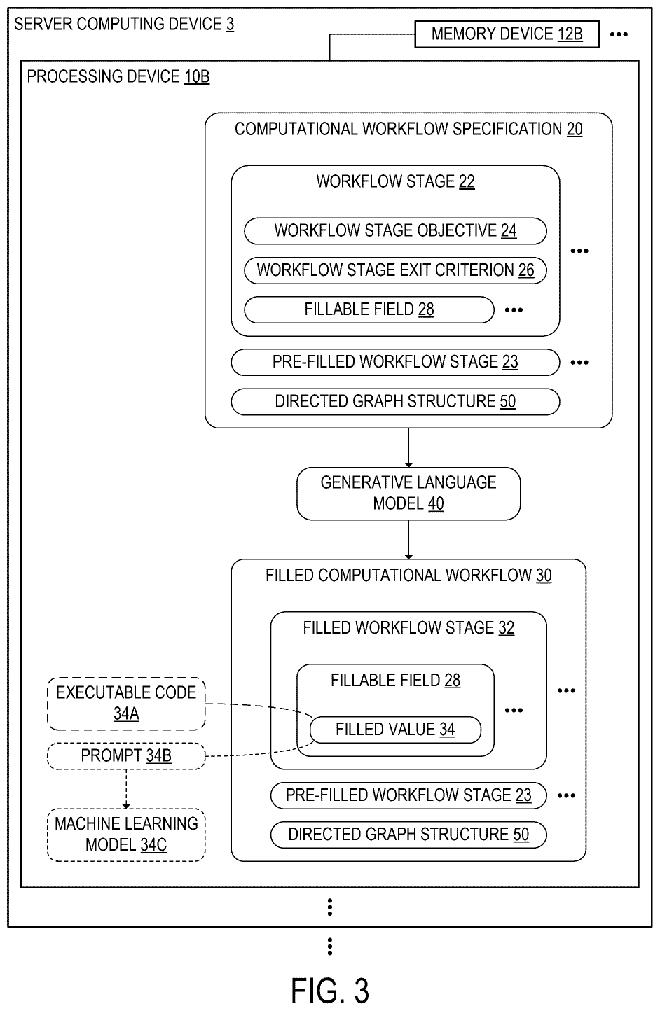

FIG. 3 schematically shows the one or more server computing devices 3 in additional detail. The one or more processing devices 10B are configured to receive the computational workflow specification 20 from the developer computing device 2. The one or more processing devices 10B are further configured to compute a filled computational workflow 30 including one or more filled workflow stages 32. The filled workflow stages 32 are computed based at least in part on the computational workflow specification 20 and include one or more respective filled values 34 of the one or more fillable fields 28.

In some examples, at least one of the filled values 34 included in the filled computational workflow 30 may be executable code 34A. As another example, at least one of the filled values 34 included in the filled computational workflow 30 may be a prompt 34B of a machine learning model 34C included in the corresponding filled workflow stage 32. The machine learning model 34C may be a filled value 34 of another fillable field 28 included in the filled workflow stage 32 along with the fillable field 28 occupied by the prompt 34B. The machine learning model 34C may, for example, be a domain-specific machine learning model selected at the one or more processing devices 10B from among a plurality of domain-specific machine learning models associated with different areas of specialization.

The one or more processing devices 10B are configured to compute the one or more corresponding filled values 34 of the one or more fillable fields 28 at least in part at a generative language model 40. For example, the generative language model 40 may be used to programmatically generate executable code 34A or a prompt 34B that is used to fill a fillable field 28. As another example, the generative language model 40 may be used as a classifier with which the one or more processing devices 10B are configured to select a machine learning model 34C by matching contents of the computational workflow specification 20 to a domain or computational task of that machine learning model 34C. In some examples, the one or more processing devices 10B may be configured to perform post-processing on an output of the generative language model 40 to obtain the filled value 34. For example, post-processing may be performed on code generated at the generative language model 40 to check the code for syntax errors.

When the generative language model 40 computes the one or more filled values 34 for an unfilled workflow stage 22, the workflow stage objective 24 and the workflow stage exit criterion 26 are input into the context of the generative language model 40, along with a system prompt. Thus, the generative language model 40 is configured to compute a filled workflow stage 32 that pursues the workflow stage objective 24 and terminates at the workflow stage exit criterion 26. Other portions of the computational workflow specification 20 may also be included in the context during computation of the one or more filled values 34. The directed graph structure 50 may be included in the context in order to set the input and output types of the filled workflow stages 32 to types that are output by prior workflow stages 21 and received as input at subsequent workflow stages 21, respectively. The entire computational workflow specification 20 may be loaded into the context of the generative language model 40 in some examples when the one or more filled values 34 are computed.

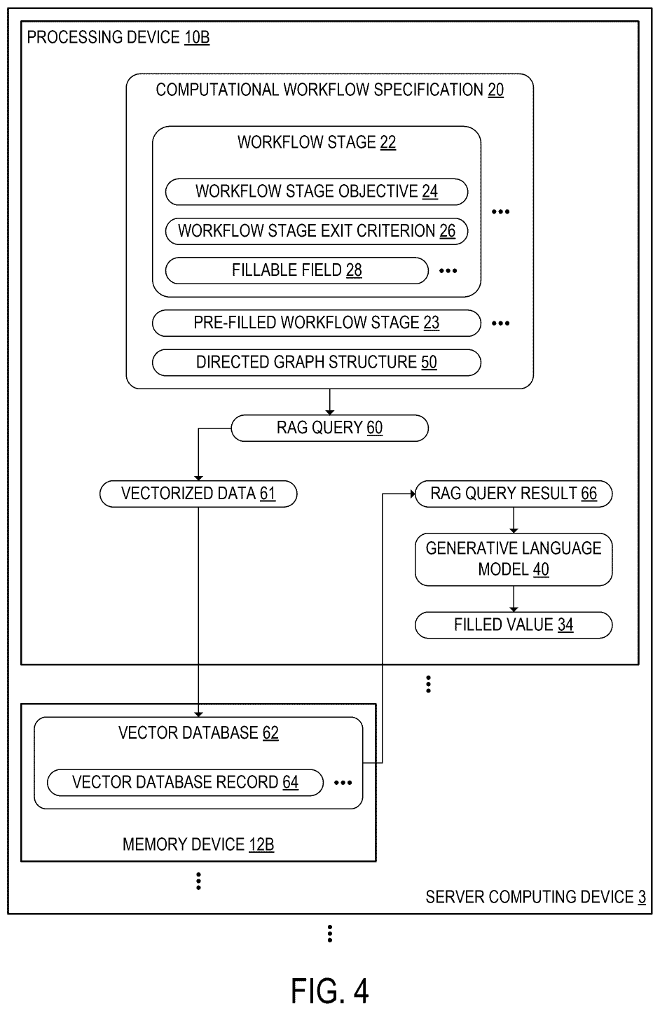

FIG. 4 schematically shows the one or more server computing devices 3 in an example in which the one or more processing devices 10B are further configured to perform retrieval-augmented generation (RAG). During computation of the filled value 34 of at least one of the unfilled workflow stages 22, the one or more processing devices 10B are further configured to perform RAG based at least in part on the workflow stage objective 24 and/or the workflow stage exit criterion 26 of the unfilled workflow stage 22. When the one or more processing devices 10B perform RAG, the one or more processing devices 10B may be configured to generate a RAG query 60 based at least in part on the workflow stage objective 24 and/or the workflow stage exit criterion 26 of the unfilled workflow stage 22. In some examples, the one or more processing devices 10B may be configured to generate the RAG query 60 at the generative language model 40.

In the example of FIG. 4, the one or more processing devices 10B are further configured to execute the RAG query 60 at a vector database 62 to obtain a RAG query result 66. The vector database 62 is stored in the one or more memory devices 12B and includes a plurality of vector database records 64. Executing the RAG query 60 may include vectorizing data included in the RAG query 60 and comparing that vectorized data 61 to the vector database records 64 stored in the vector database 62. For example, the one or more processing devices 10B may be configured to compute respective cosine similarities between the vectorized data 61 and the vector database records 64. The one or more processing devices 10B may, in this example, be further configured to select a vector database record 64 with a cosine similarity value above a cosine similarity threshold as the RAG query result 66.

The one or more processing devices 10B may be further configured to compute the filled value 34 based at least in part on the RAG query result 66. In the example of FIG. 4, the RAG query result 66 is loaded into the context of the generative language model 40. By performing RAG when filling the one or more fillable fields 28, the one or more processing devices 10B are able to generate the one or more filled values 34 using additional information that is not included in the computational workflow specification 20. For example, RAG may be used to incorporate, into the context of the generative language model 40, information retrieved from a database that would be too large to include in the context in its entirety.

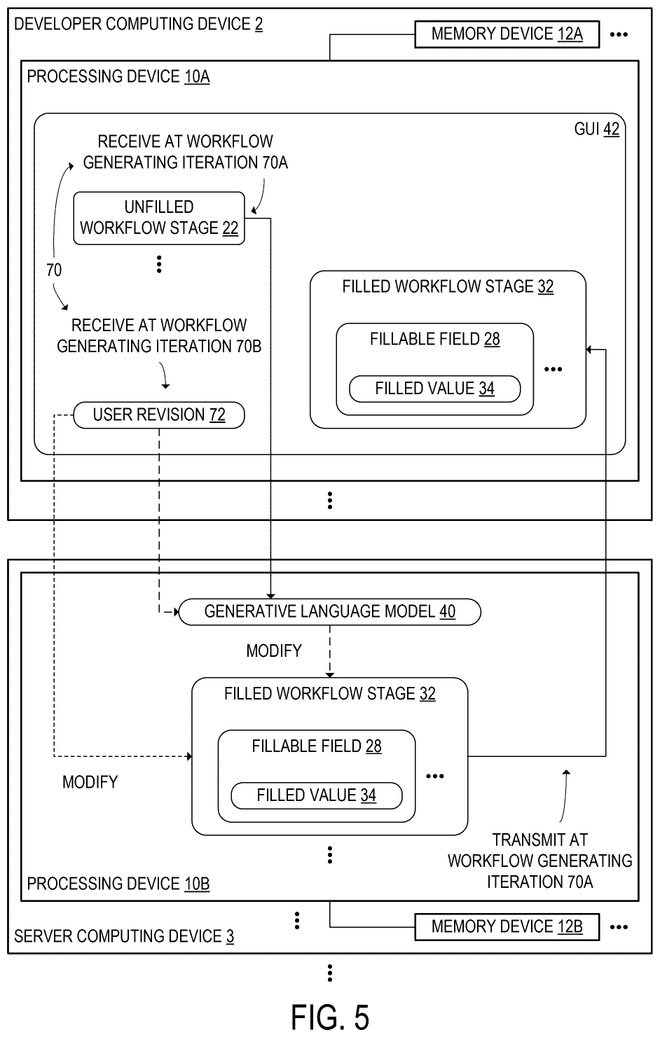

FIG. 5 schematically shows the developer computing device 2 and the one or more server computing devices 3 in an example in which the one or more processing devices 10 are configured to receive the computational workflow specification 20 and generate the filled computational workflow 30 over a plurality of workflow generating iterations 70. The workflow generating iterations 70 are back-and-forth turns exchanged between the developer computing device 2 and the server computing device 3 to iteratively construct the filled computational workflow 30. These workflow generating iterations 70 may include a plurality of workflow generating iterations 70A in which portions of the computational workflow specification 20 are iteratively received. At each of the workflow generating iterations 70A, the one or more processing devices 10 are configured to receive an unfilled workflow stage 22 of the one or more unfilled workflow stages 22 via a user interface. The unfilled workflow stage 22 is received via the GUI 42 at the one or more processing devices 10A of the developer computing device 2 in the example of FIG. 5.

The one or more processing devices 10A are further configured to transmit the unfilled workflow stage 22 to the server computing device 3 during that workflow generating iteration 70A. The one or more processing devices 10B of the server computing device 3 are further configured to generate the one or more filled values 34 included in the filled workflow stage 32 as discussed above, and to transmit the filled workflow stage 32 back to the developer computing device 2. At each of the workflow generating iterations 70A, the one or more processing devices 10 are further configured to output the filled workflow stage 32 to the user interface. Thus, the developer may review the one or more filled values 34.

In some examples, in at least one of the workflow generating iterations 70, the one or more processing devices 10 may be further configured to receive a user revision 72 to the filled value 34 of a fillable field 28. The user revision 72, in the example of FIG. 5, is received in a workflow generating iteration 70B, which may, in some examples, be distinct from the workflow generation iterations 70A in which the one or more unfilled workflow stages 22 are received and processed. In other examples, the one or more processing devices 10 may be configured to receive an unfilled workflow stage 22 and a user revision 72 in the same workflow generating iteration 70. The one or more processing devices 10B of the server computing device 3 are further configured to modify the filled value 34 as specified by the user revision 72. The developer may accordingly correct errors and/or modify the functionality of the filled field 34 computed using the generative language model 40.

In some examples, the user revision 72 may modify the filled value 34 directly. In other examples, the user revision 72 may include an instruction to regenerate a filled value 34, in which case the one or more processing devices 10B are configured to process the user revision 72 at the generative language model 40. The user revision 72 may, in such examples, include additional input for inclusion in the context of the generative language model 40 when the filled value 34 is regenerated. For example, the developer may clarify the workflow stage objective 24 and/or the workflow stage exit criterion 26 using this additional information provided in the user revision 72. Thus, the developer may revise the output of the generative language model 40 and/or the input with which that output is generated.

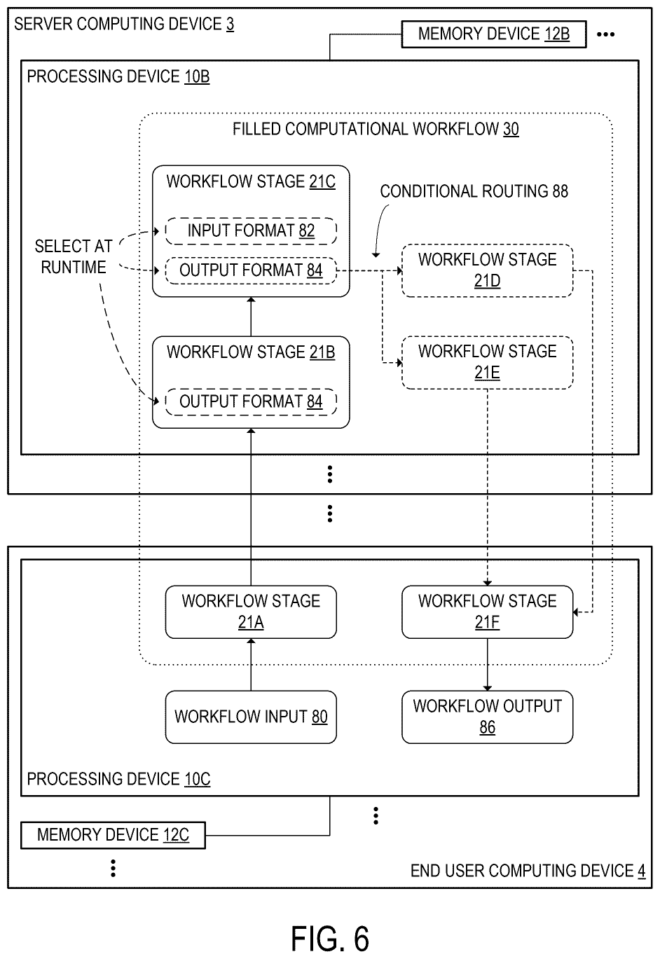

FIG. 6 schematically shows the one or more server computing devices 3 and the end user computing device 4 during execution of the filled computational workflow 30, according to one example. In the example of FIG. 6, the filled computational workflow 30 includes workflow stages 21 that are executed at the one or more server computing devices 3 and workflow stages 21 that are executed at the end user computing device 4. The example filled computational workflow 30 of FIG. 6 receives a workflow input 80 and outputs a workflow output 86 at the one or more processing devices 10C of the end user computing device 4. However, in other examples, the workflow input 80 and/or the workflow output 86 may occur at some other location, such as the one or more server computing devices 3 or another end user computing device 4.

In the example of FIG. 6, the one or more processing devices 10C of the end user computing device 4 are configured to execute a workflow stage 21A on the workflow input 80 and pass an output of that workflow stage 21A to a workflow stage 21B executed at the one or more processing devices 10B of the one or more server computing devices 3. The one or more processing devices 10B are configured to dynamically select an input format 82 and/or an output format 84 of at least one workflow stage 21 of the plurality of workflow stages 21. The one or more processing devices 10B shown in the example of FIG. 6 are configured to select the output format 84 of the workflow stage 21B at runtime. This output format 84 is also the input format 82 of a subsequent workflow stage 21C. In addition, the one or more processing devices 10B are further configured to select the output format 84 of the workflow stage 21C during execution of the filled computational workflow 30. By dynamically selecting the input and output types of workflow stages 21, the one or more processing devices 10B may adapt the computing processes performed in the filled computational workflow 30 to account for differences between instances in which the filled computational workflow 30 is executed.

During execution of the filled computational workflow 30, according to the example of FIG. 6, the one or more processing devices 10B are further configured to perform conditional routing 88 of a respective output of at least one workflow stage 21 of the plurality of workflow stages 21. Conditional routing is the selection of a subsequent workflow stage 21 from among a plurality of workflow stages 21 according to one or more properties of an output of the current workflow stage 21.

In this example, the one or more processing devices 10B are configured to select between a workflow stage 21D and a workflow stage 21E as an output of the workflow stage 21C. This conditional routing 88 may, for example, be performed at the workflow stage 21C according to the selected output format 84, such that an output of the workflow stage 21C with a first output format is routed to the workflow stage 21D and an output with a second output format is routed to the workflow stage 21E. For example, text outputs and image outputs of the workflow stage 21C may be routed to different destination workflow stages. In some examples, both workflow stage 21D and workflow stage 21E may be executed and may receive different portions of the output of the workflow stage 21C as input.

The filled computational workflow 30 of FIG. 6 further includes a workflow stage 21F that is executed at the one or more processing devices 10C of the end user computing device 4 to compute the workflow output 86. The workflow stage 21F is configured to receive input from the workflow stage 21D and/or the workflow stage 21E. In examples in which both workflow stage 21D and workflow stage 21E are executed, a fan-in pattern 54 may be executed when the workflow stage 21F receives input.

In the example of FIG. 6, the paths between different workflow stages 21 of the filled computational workflow 30 are specified within the individual workflow stages rather than being specified at an orchestrator in a top-down manner. When the filled workflow stages 32 are generated, input-output routing within the filled computational workflow 30 may be specified in the filled values 34 of the fillable fields 28. One or more pre-filled workflow stages 23 may also include input-output routing instructions. By not requiring a centralized orchestrator to route inputs and outputs of the workflow stages 21, communication between different computing devices may be reduced, thereby reducing the latency of executing the filled computational workflow 30.

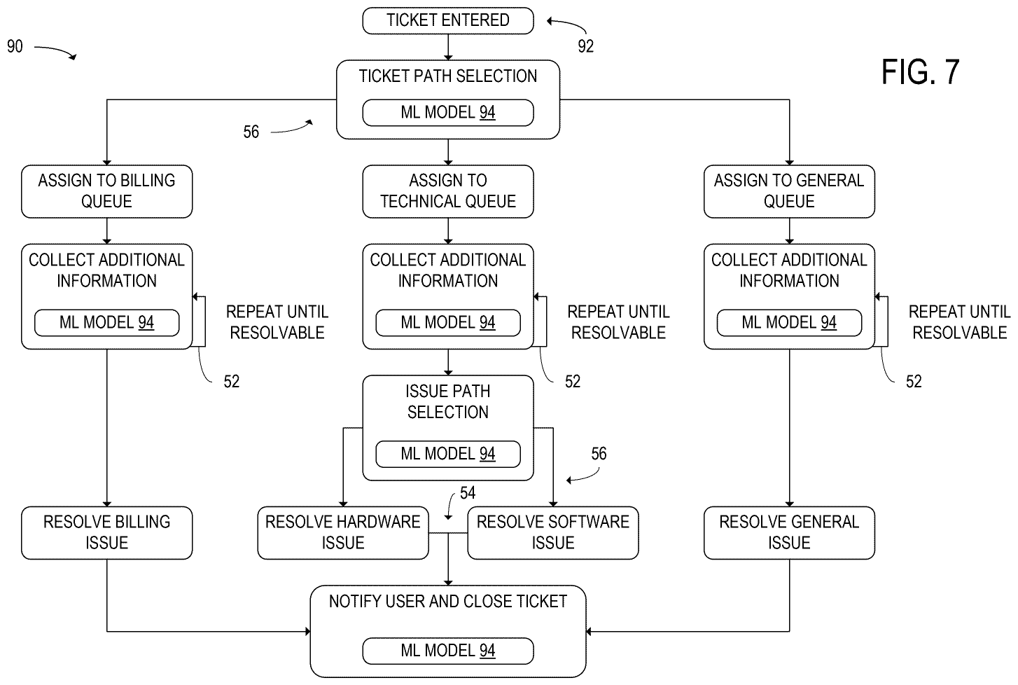

FIG. 7 schematically shows an example filled computational workflow 90 that is executed to perform ticketing support for an end user. The example of FIG. 7 shows the workflow stages 92 included in the filled computational workflow 90 and the structure in which those workflow stages 92 are arranged. In some of the workflow stages 92, the one or more processing devices 10 are configured to execute an ML model 94. This ML model 94 may be a generative language model that is configured to perform natural language processing on text entered by the user. The ML model 94 is executed, for example, when selecting a ticket path (a billing queue, a technical queue, or a general queue) for a support ticket entered by the user. The ML model 94 is also executed when collecting additional information related to the support ticket via conversational turns exchanged with the user; when selecting whether a technical support ticket reports a hardware issue or a software issue; and when notifying the user that the issue has been resolved. The same ML model 94 is used at these workflow stages 92 in some examples, whereas in other examples, the filled computational workflow 90 may include calls to a plurality of different ML models 94.

In the example of FIG. 7, the filled computational workflow 90 has a DCG structure that includes respective cycle patterns 52 when collecting additional information from the user. The filled computational workflow 90 also has a fan-out pattern 56 at ticket path selection, a fan-out pattern 56 at technical issue path selection, and a fan-in pattern 54 at notification of ticket resolution. The filled computational workflow 90 therefore allows for variable numbers of conversational turns when collecting the additional information and allows for the execution of different branches depending on the outputs of some workflow stages 92.

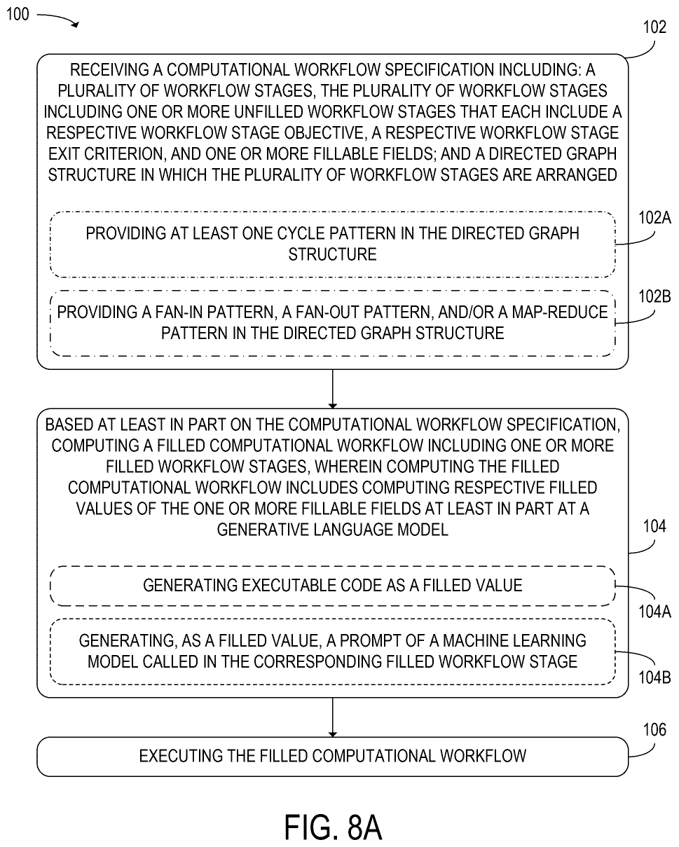

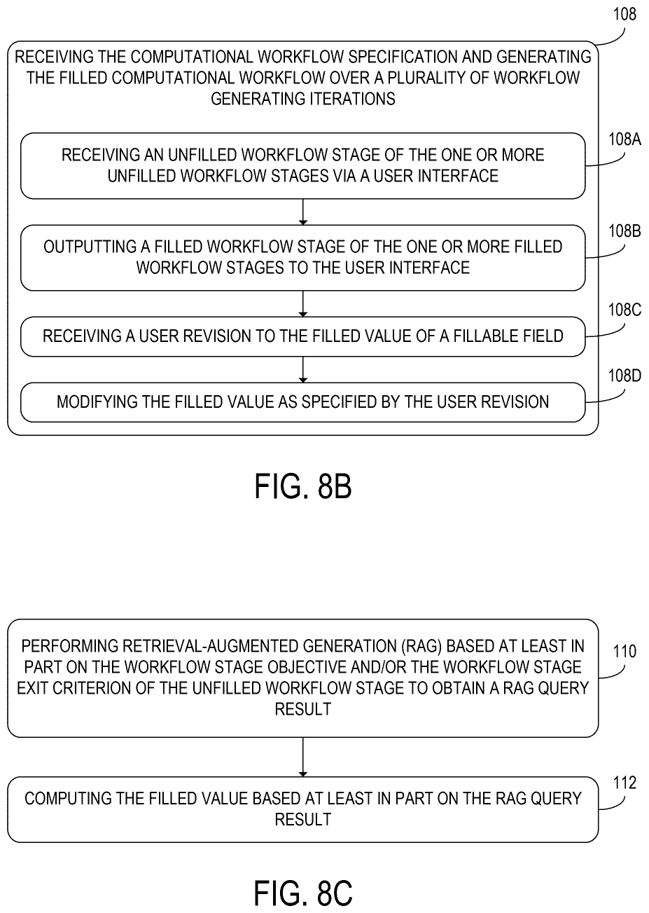

FIG. 8A shows a flowchart of a method 100 for use with a computing system, according to one example embodiment. At step 102, the method 100 includes receiving a computational workflow specification. The computational workflow specification includes a plurality of workflow stages, among which one or more unfilled workflow stages are provided. The unfilled workflow stages each include a respective workflow stage objective and a respective workflow stage exit criterion. The workflow stage objective and the workflow stage exit criterion may, for example, be specified as natural language inputs. Each unfilled workflow stage further includes one or more fillable fields, which are configured to be programmatically filled as discussed below. In some examples, the computational workflow specification may further include one or more pre-filled workflow stages that do not include respective fillable fields.

The computational workflow specification further includes a directed graph structure in which the plurality of workflow stages are arranged. In the directed graph structure, the workflow stages are nodes connected by a plurality of directed edges that indicate paths between the workflow stages. In some examples, at step 102A, step 102 may further include providing at least one cycle pattern in the directed graph structure. Thus, in such examples, the directed graph structure is a DCG. Additionally or alternatively, at step 102B, step 102 may further include providing a fan-in pattern, a fan-out pattern, and/or a map-reduce pattern in the directed graph structure. Thus, branching input-output structures may be included in the computational workflow.

At step 104, the method 100 further includes computing a filled computational workflow based at least in part on the computational workflow specification. The filled computational workflow includes one or more filled workflow stages that are obtained by computing respective filled values of the one or more fillable fields included in the one or more unfilled workflow stages. The one or more filled values are computed at least in part at a generative language model, which may, for example, be an LLM or an LMM. Pre-processing and/or post-processing may also be performed on the inputs and/or outputs of the generative language model. In some examples, the entire computational workflow specification may be included in the context of the generative language model when computing the filled values.

In some examples, at step 104A, step 104 may include generating executable code as a filled value of at least one of the one or more fillable fields. At step 104B, step 104 may additionally or alternatively include generating a prompt of an ML model as a filled value. In such examples, the ML model may be a model called by executable code included in the filled workflow stage that includes the prompt. An unfilled workflow stage may, for example, include a first fillable field configured to be filled with a selection of an ML model from among a plurality of different ML models. That unfilled workflow stage may further include a second fillable field configured to be filled with a prompt. When the filled workflow stage is generated, the generative language model may select the ML model and compute the prompt for that ML model.

At step 106, the method 100 further includes executing the filled computational workflow. The computational workflow may be executed at one or more server computing devices and/or one or more end user client computing devices. For example, executing the filled computational workflow may include rounds of back-and-forth communication between a user interface of an end user computing device and an ML system executed at one or more server computing devices.

FIG. 8B shows additional steps of the method 100 that may be performed in some examples. At step 108, the method 100 may include receiving the computational workflow specification and generating the filled computational workflow over a plurality of workflow generating iterations. Accordingly, portions of the computational workflow specification may be received as different inputs. At step 108A, in at least one of the workflow generating iterations, step 108 may include receiving an unfilled workflow stage of the one or more unfilled workflow stages via a user interface. The user interface may be a GUI executed at a developer computing device. At step 108B, step 108 may further include outputting a filled workflow stage of the one or more filled workflow stages to the user interface. The developer may accordingly review the one or more filled values computed using the generative language model.

In some examples, at step 108C, step 108 may include receiving a user revision to the filled value of a fillable field in at least one of the workflow generating iterations. In such examples, at step 108D, step 108 may further include modifying the filled value as specified by the user revision. Thus, the developer may revise the filled values computed at the generative language model.

FIG. 8C shows additional steps of the method 100 that may be performed in some examples during computation of the filled value of at least one of the unfilled workflow stages. At step 110, the method 100 may further include performing retrieval-augmented generation (RAG) based at least in part on the workflow stage objective and/or the workflow stage exit criterion of the unfilled workflow stage to obtain a RAG query result. When RAG is performed, the RAG query result is retrieved from a vector database according to similarity values computed between vector database records and vectorized data specified by the RAG query. At step 112, the method 100 may further include computing the filled value based at least in part on the RAG query result. Thus, one or more of the vector database records may be loaded into the context of the generative language model. By performing RAG, an ML system that includes the generative language model may incorporate data sources from outside the computational workflow specification when filling the one or more fillable fields.

FIG. 8D shows additional steps of the method 100 that may be performed during execution of the filled computational workflow. At step 114, the method 100 may further include dynamically selecting an input format and/or an output format of at least one workflow stage of the plurality of workflow stages. Accordingly, a workflow stage may receive inputs that have different input formats, and/or compute outputs that have different output formats, at different respective instances in which that workflow stage is executed.

At step 116, the method 100 may additionally or alternatively include performing conditional routing of a respective output of at least one workflow stage of the plurality of workflow stages. For example, outputs of the at least one workflow stage that have different formats may be routed to different respective destination workflow stages.

With the systems and methods discussed above, portions of a computational workflow are programmatically generated by using a generative language model to fill one or more fillable fields. The generative language model fills those fields as specified in workflow stage objectives and workflow stage exit criteria specified by a developer. Accordingly, the systems and methods discussed above utilize the programming capabilities and the natural language modeling capabilities of the generative language model to facilitate computational workflow development. By defining the workflow stage objective and workflow stage exit criterion for a workflow stage rather than directly specifying input and output types for the workflow stage, the computational workflow specification allows the generative language model to programmatically select the input and output types. This programmatic type selection may allow for greater flexibility in the structure of the filled computational workflow, since the developer does not have to explicitly specify all eligible input and output types of the workflow stages. The above systems and methods also allow for a greater variety of workflow structures, such as those that include cycle patterns, fan-in patterns, fan-out patterns, and/or map-reduce patterns.

The methods and processes described herein are tied to a computing system of one or more computing devices. In particular, such methods and processes can be implemented as a computer-application program or service, an application-programming interface (API), a library, and/or other computer-program product.

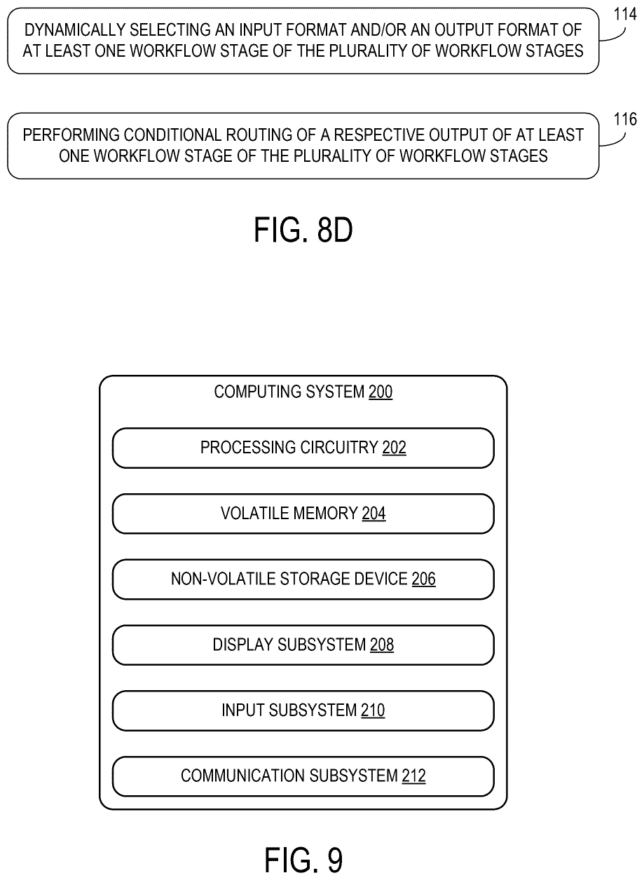

FIG. 9 schematically shows a non-limiting embodiment of a computing system 200 that can enact one or more of the methods and processes described above. Computing system 200 is shown in simplified form. Computing system 200 may embody the computing system 1 described above and illustrated in FIG. 1. Components of computing system 200 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 200 includes processing circuitry 202, volatile memory 204, and a non-volatile storage device 206. Computing system 200 may optionally include a display subsystem 208, input subsystem 210, communication subsystem 212, and/or other components not shown in FIG. 9.

Processing circuitry 202 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 202 may be single-core or multi-core, and the instructions executed thereon may be configured for sequential, parallel, and/or distributed processing. Individual components of the processing circuitry 202 optionally may be distributed among two or more separate devices, which may be remotely located and/or configured for coordinated processing. For example, aspects of the computing system 200 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 202.

Non-volatile storage device 206 includes one or more physical devices configured to hold instructions executable by the processing circuitry to implement the methods and processes described herein. When such methods and processes are implemented, the state of non-volatile storage device 206 may be transformed—e.g., to hold different data.

Non-volatile storage device 206 may include physical devices that are removable and/or built in. Non-volatile storage device 206 may include optical memory, semiconductor memory, and/or magnetic memory, or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by processing circuitry 202 to temporarily store information during processing of software instructions. It will be appreciated that volatile memory 204 typically does not continue to store instructions when power is cut to the volatile memory 204.

Aspects of processing circuitry 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory 204, which function involves transformative processing that specially configures the processor to perform the function. Thus, a module, program, or engine may be instantiated via processing circuitry 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with processing circuitry 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, camera, or microphone.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 200 to send and/or receive messages to and/or from other devices via a network such as the Internet.

The following paragraphs discuss several aspects of the present disclosure. According to one aspect of the present disclosure, a computing system is provided, including one or more processing devices configured to receive a computational workflow specification including a plurality of workflow stages. The plurality of workflow stages include one or more unfilled workflow stages that each include a respective workflow stage objective, a respective workflow stage exit criterion, and one or more fillable fields. The computational workflow specification further includes a directed graph structure in which the plurality of workflow stages are arranged. Based at least in part on the computational workflow specification, the one or more processing devices are further configured to compute a filled computational workflow including one or more filled workflow stages. Computing the filled computational workflow includes computing respective filled values of the one or more fillable fields at least in part at a generative language model. The one or more processing devices are further configured to execute the filled computational workflow. By utilizing programmatic completion of the one or more fillable fields, the above features may have the technical effect of allowing the computational workflow to be generated more easily.

According to this aspect, at least one of the filled values included in the filled computational workflow may be executable code. The above feature may have the technical effect of programmatically generating executable code rather than requiring a developer to write the executable code.

According to this aspect, at least one of the filled values included in the filled computational workflow may be a prompt of a machine learning model called in the corresponding filled workflow stage. The above feature may have the technical effect of programmatically generating a prompt rather than requiring a developer to write the prompt.

According to this aspect, the one or more processing devices may be configured to receive the computational workflow specification and generate the filled computational workflow over a plurality of workflow generating iterations. In at least one of the workflow generating iterations, the one or more processing devices may be configured to receive an unfilled workflow stage of the one or more unfilled workflow stages via a user interface. The one or more processing devices may be further configured to output a filled workflow stage of the one or more filled workflow stages to the user interface. The above features may have the technical effect of iteratively constructing the computational workflow over a plurality of back-and-forth turns.

According to this aspect, in at least one of the workflow generating iterations, the one or more processing devices may be further configured to receive a user revision to the filled value of a fillable field. The one or more processing devices may be further configured to modify the filled value as specified by the user revision. The above features may have the technical effect of correcting and guiding the computation of the filled computational workflow using at least one user revision.

According to this aspect, during computation of the filled value of at least one of the unfilled workflow stages, the one or more processing devices may be further configured to perform retrieval-augmented generation (RAG) based at least in part on the workflow stage objective and/or the workflow stage exit criterion of the unfilled workflow stage to obtain a RAG query result. The one or more processing devices may be further configured to compute the filled value based at least in part on the RAG query result. The above features may have the technical effect of generating the filled value using additional information not included in the computational workflow specification.

According to this aspect, the directed graph structure may include at least one cycle pattern. The above feature may have the technical effect of including at least one recursively executed workflow stage in the computational workflow.

According to this aspect, the directed graph structure may include a fan-in pattern, a fan-out pattern, and/or a map-reduce pattern. The above features may have the technical effect of including branching structures in the computational workflow.

According to this aspect, during execution of the filled computational workflow, the one or more processing devices may be configured to dynamically select an input format and/or an output format of at least one workflow stage of the plurality of workflow stages. The above features may have the technical effect of adapting the computing processes performed in the filled computational workflow to account for differences between instances in which the filled computational workflow is executed.

According to this aspect, during execution of the filled computational workflow, the one or more processing devices may be configured to perform conditional routing of a respective output of at least one workflow stage of the plurality of workflow stages. The above features may have the technical effect of dynamically selecting a path through the filled computational workflow according to properties of a specific instance in which the filled computational workflow is executed.

According to another aspect of the present disclosure, a method for use with a computing system is provided. The method includes receiving a computational workflow specification including a plurality of workflow stages. The plurality of workflow stages include one or more unfilled workflow stages that each include a respective workflow stage objective, a respective workflow stage exit criterion, and one or more fillable fields. The computational workflow specification further includes a directed graph structure in which the plurality of workflow stages are arranged. Based at least in part on the computational workflow specification, the method further includes computing a filled computational workflow including one or more filled workflow stages. Computing the filled computational workflow includes computing respective filled values of the one or more fillable fields at least in part at a generative language model. The method further includes executing the filled computational workflow. By utilizing programmatic completion of the one or more fillable fields, the above features may have the technical effect of allowing the computational workflow to be generated more easily.

According to this aspect, at least one of the filled values included in the filled computational workflow may be executable code. The above feature may have the technical effect of programmatically generating executable code rather than requiring a developer to write the executable code.

According to this aspect, at least one of the filled values included in the filled computational workflow may be a prompt of a machine learning model called in the corresponding filled workflow stage. The above feature may have the technical effect of programmatically generating a prompt rather than requiring a developer to write the prompt.

According to this aspect, the method may further include receiving the computational workflow specification and generating the filled computational workflow over a plurality of workflow generating iterations. In at least one of the workflow generating iterations, the method may further include receiving an unfilled workflow stage of the one or more unfilled workflow stages via a user interface. The method may further include outputting a filled workflow stage of the one or more filled workflow stages to the user interface. The above features may have the technical effect of iteratively constructing the computational workflow over a plurality of back-and-forth turns.

According to this aspect, in at least one of the workflow generating iterations, the method may further include receiving a user revision to the filled value of a fillable field. The method may further include modifying the filled value as specified by the user revision. The above features may have the technical effect of correcting and guiding the computation of the filled computational workflow using at least one user revision.

According to this aspect, during computation of the filled value of at least one of the unfilled workflow stages, the method may further include performing retrieval-augmented generation (RAG) based at least in part on the workflow stage objective and/or the workflow stage exit criterion of the unfilled workflow stage to obtain a RAG query result. The method may further include computing the filled value based at least in part on the RAG query result. The above features may have the technical effect of generating the filled value using additional information not included in the computational workflow specification.

According to this aspect, the directed graph structure may include at least one cycle pattern. The above feature may have the technical effect of including at least one recursively executed workflow stage in the computational workflow.

According to this aspect, the directed graph structure includes a fan-in pattern, a fan-out pattern, and/or a map-reduce pattern. The above features may have the technical effect of including branching structures in the computational workflow.

According to this aspect, the method may further include, during execution of the filled computational workflow, performing conditional routing of a respective output of at least one workflow stage of the plurality of workflow stages. The above features may have the technical effect of dynamically selecting a path through the filled computational workflow according to properties of a specific instance in which the filled computational workflow is executed.

According to another aspect of the present disclosure, a computing system is provided, including one or more processing devices configured to receive a computational workflow specification including a plurality of workflow stages. The plurality of workflow stages include a plurality of unfilled workflow stages that each include a respective workflow stage objective, a respective workflow stage exit criterion, and one or more fillable fields. The computational workflow specification further includes a directed graph structure in which the plurality of workflow stages are arranged. Based at least in part on the computational workflow specification, the one or more processing devices are further configured to compute a filled computational workflow including one or more filled workflow stages. Computing the filled computational workflow includes computing respective filled values of the one or more fillable fields at least in part at a generative language model. At least one of the filled values included in the filled computational workflow is executable code. At least one of the filled values included in the filled computational workflow is a prompt of a machine learning model called in the corresponding filled workflow stage. The one or more processing devices are further configured to execute the filled computational workflow. By utilizing programmatic completion of the fillable fields, the above features may have the technical effect of allowing the computational workflow to be generated more easily.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive a computational workflow specification including:
a plurality of workflow stages, the plurality of workflow stages including one or more unfilled workflow stages that each include:
a respective workflow stage objective;
a respective workflow stage exit criterion; and
one or more fillable fields; and
a directed graph structure in which the plurality of workflow stages are arranged;
based at least in part on the computational workflow specification, compute a filled computational workflow including one or more filled workflow stages, wherein computing the filled computational workflow includes computing respective filled values of the one or more fillable fields at least in part at a generative language model; and
execute the filled computational workflow.

2. The computing system of claim 1, wherein at least one of the filled values included in the filled computational workflow is executable code.

3. The computing system of claim 1, wherein at least one of the filled values included in the filled computational workflow is a prompt of a machine learning model called in the corresponding filled workflow stage.

4. The computing system of claim 1, wherein:
the one or more processing devices are configured to receive the computational workflow specification and generate the filled computational workflow over a plurality of workflow generating iterations; and
in at least one of the workflow generating iterations, the one or more processing devices are configured to:
receive an unfilled workflow stage of the one or more unfilled workflow stages via a user interface; and
output a filled workflow stage of the one or more filled workflow stages to the user interface.

5. The computing system of claim 4, wherein, in at least one of the workflow generating iterations, the one or more processing devices are further configured to:
receive a user revision to the filled value of a fillable field; and
modify the filled value as specified by the user revision.

6. The computing system of claim 1, wherein, during computation of the filled value of at least one of the unfilled workflow stages, the one or more processing devices are further configured to:
perform retrieval-augmented generation (RAG) based at least in part on the workflow stage objective and/or the workflow stage exit criterion of the unfilled workflow stage to obtain a RAG query result; and
compute the filled value based at least in part on the RAG query result.

7. The computing system of claim 1, wherein the directed graph structure includes at least one cycle pattern.

8. The computing system of claim 1, wherein the directed graph structure includes a fan-in pattern, a fan-out pattern, and/or a map-reduce pattern.

9. The computing system of claim 1, wherein, during execution of the filled computational workflow, the one or more processing devices are configured to dynamically select an input format and/or an output format of at least one workflow stage of the plurality of workflow stages.

10. The computing system of claim 1, wherein, during execution of the filled computational workflow, the one or more processing devices are configured to perform conditional routing of a respective output of at least one workflow stage of the plurality of workflow stages.

11. A method for use with a computing system, the method comprising:
receiving a computational workflow specification including:
a plurality of workflow stages, the plurality of workflow stages including one or more unfilled workflow stages that each include:
a respective workflow stage objective;
a respective workflow stage exit criterion; and
one or more fillable fields; and
a directed graph structure in which the plurality of workflow stages are arranged;
based at least in part on the computational workflow specification, computing a filled computational workflow including one or more filled workflow stages, wherein computing the filled computational workflow includes computing respective filled values of the one or more fillable fields at least in part at a generative language model; and
executing the filled computational workflow.

12. The method of claim 11, wherein at least one of the filled values included in the filled computational workflow is executable code.

13. The method of claim 11, wherein at least one of the filled values included in the filled computational workflow is a prompt of a machine learning model called in the corresponding filled workflow stage.

14. The method of claim 11, further comprising:
receiving the computational workflow specification and generating the filled computational workflow over a plurality of workflow generating iterations; and
in at least one of the workflow generating iterations:
receiving an unfilled workflow stage of the one or more unfilled workflow stages via a user interface; and
outputting a filled workflow stage of the one or more filled workflow stages to the user interface.

15. The method of claim 14, further comprising, in at least one of the workflow generating iterations:
receiving a user revision to the filled value of a fillable field; and
modifying the filled value as specified by the user revision.

16. The method of claim 11, further comprising, during computation of the filled value of at least one of the unfilled workflow stages:
performing retrieval-augmented generation (RAG) based at least in part on the workflow stage objective and/or the workflow stage exit criterion of the unfilled workflow stage to obtain a RAG query result; and
computing the filled value based at least in part on the RAG query result.

17. The method of claim 11, wherein the directed graph structure includes at least one cycle pattern.

18. The method of claim 11, wherein the directed graph structure includes a fan-in pattern, a fan-out pattern, and/or a map-reduce pattern.

19. The method of claim 11, further comprising, during execution of the filled computational workflow, performing conditional routing of a respective output of at least one workflow stage of the plurality of workflow stages.

20. A computing system comprising:
one or more processing devices configured to:
receive a computational workflow specification including:
a plurality of workflow stages, the plurality of workflow stages including a plurality of unfilled workflow stages that each include:
a respective workflow stage objective;
a respective workflow stage exit criterion; and
one or more fillable fields; and
a directed graph structure in which the plurality of workflow stages are arranged;
based at least in part on the computational workflow specification, compute a filled computational workflow including one or more filled workflow stages, wherein:
computing the filled computational workflow includes computing respective filled values of the one or more fillable fields at least in part at a generative language model;
at least one of the filled values included in the filled computational workflow is executable code; and
at least one of the filled values included in the filled computational workflow is a prompt of a machine learning model called in the corresponding filled workflow stage; and
execute the filled computational workflow.
